(19) United States
(12) Patent Application Publication
(10) Pub. No.: US 2022/0091142 A1
(43) Pub. Date: Mar. 24, 2022

(54) MULTI-CHANNEL POTENTIOSTAT

(71) Applicant: Zensor R&D Company, Taichung (TW)

(72) Inventor: Hsieh-Hsun Chung, Taichung (TW)

(21) Appl. No.: 17/378,705

(22) Filed: Jul. 17, 2021

(30) Foreign Application Priority Data
Sep. 24, 2020 (TW) 109133141

(51) Int. Cl. G01N 35/00; G08C 17/02

(52) U.S. Cl. CPC G01N 35/00584; G01N 35/00871; G08C 17/02

(57) ABSTRACT

A multi-channel potentiostat is provided and includes one or more than one test dongles and a remote controller. The test dongle comprises a battery, a power switch, a detector, a processor, a memory, a controller, a detector receiving port, a first wireless transceiver, a USB connector and a USB protective cover. The remote controller comprises a plurality of USB receiving ports, a memory, a second wireless transceiver, a power switch, a power connector, a transmission port, and a battery. The test dongles execute a process of electrochemical analysis on an analyte, and transmit an analysis data to the remote controller. Afterward, the remote controller transmits the analysis data to a processing device for analysis. The multi-channel potentiostat has the advantages, for example processing analysis data at the same time, small size for easy to carry and making the detection distance wider by the wireless transmission.

### CROSS-REFERENCE TO RELATED APPLICATIONS

This application claims the benefit of Taiwan Patent Application No. 109133141, filed on Sep. 24, 2020, in the Taiwan Intellectual Property Office, the disclosure of which is incorporated herein in its entirety by reference.

### BACKGROUND OF THE INVENTION

### 1. Field of the Invention

The present invention relates to a potentiostat, more particularly to a multi-channel potentiostat with advantages of simultaneously processing of multiple sets of data, being small in size for better portability and allowing remote analysis of analytes.

### 2. Description of the Related Art

The conventional potentiostat is a device which is used in the laboratory to examine the analyte and analyze the constitution or the concentration thereof. Generally, the size is not the key factor to be considered during the design of the potentiostat. Hence, most electrochemical analyzing devices in the market are not designed to be portable. Therefore, it is necessary to take the samples of the analyte to the laboratory to be examined and analyzed, which would waste more time and cause inconvenience of acquiring the result of the analysis.

Furthermore, the conventional potentiostat is merely an examination device which receives the analyte and generates electrochemical reaction during examination. When detecting a voltage or a current, the conventional potentiostat needs to transmit the detected results to the computer or the workstation to conduct the process of electrochemical analysis, such as that processes of signal interpretation or signal conversion. This configuration requires the conventional potentiostat to connect to the computer to conduct the process of electrochemical analysis rather than stand-alone operation, and the convenience of use is apparently limited. Recently, even though the portable potentiostat is developed, only certain specific analytes can be examined by such portable machines, for example, measuring the blood glucose by the blood glucose meter, or under some different circumstances examining the analyte such as the specific contaminant in gas or liquid. The examination processes and the parameter settings cannot be changed in these specific potentiostats, and therefore unable to deal with the different analytes.

Moreover, in addition to the drawbacks that the conventional portable potentiostat is limited to specific analytes, the conventional portable potentiostat is also unable to concurrently examine multiple analytes at the same time, which takes much more time to examine these analytes. Generally speaking, the conventional portable potentiostat is equipped with the ability of wireless communication, but the conventional portable potentiostat can merely connected to one computer or one mobile device at a time, such that it would be time consuming when a plurality sets of examination data of the analytes need to be processed. The wireless transmission distance of the computer or the mobile device is also short, and the conventional potentiostat is unable to be remotely manipulated.

From the foregoing perspective, the potentiostat is expected to have the abilities to analyze different analytes, to handle multiple sets of analytes simultaneously and to be remotely manipulated. Such abilities would allow stand-alone operation of the potentiostat during examination, and there is no need to connect the potentiostat with other equipments to conduct the process of electrochemical analysis.

### SUMMARY OF THE INVENTION

In order to solve conventional problem, the present invention provides a multi-channel potentiostat, which improve the shortcomings such as unable to be portable for examination, unable to change the target detection, unable to examine a number of analytes simultaneously and unable to be manipulated remotely.

Based on the foregoing objective, the embodiments of the present invention provide a multi-channel potentiostat which includes a plurality of test dongles and a remote controller. Each test dongle is configured to perform an electrochemical analysis on an analyte to produce analytic data thereof. Each of the plurality of test dongles includes a detector receiving port, a detector, a controller and a first memory. The detector is coupled to the detector receiving port and is configured to receive the analyte. The controller is electrically connected to the detector and instructs the detector to apply a testing signal to the analyte to obtain a response signal. The processor is electrically connected to the controller and calculates the analytic data based on the response signal. The first memory is electrically connected to the processor to store the analytic data. The remote controller includes a second memory. The remote controller establishes data communication with each of the plurality of testing dongles to receive the analytic data stored in the first memory and store the analytic data in the second memory. The plurality of testing dongles are configured to concurrently perform the electrochemical analysis.

Optionally, the plurality of test dongles are detachably coupled to the remote controller.

Optionally, the remote controller further includes one or more I/O receiving ports and each of the plurality of test dongles further includes an I/O connector. Each of the I/O connector is configured to physically couple to one of the I/O receiving ports to transmit the analytic data from the test dongle to the remote controller. The I/O connector may be USB connector. One or more I/O receiving ports may be USB receiving ports.

Optionally the remote controller provides power to the test dongle by coupling between the I/O connector and the I/O receiving port.

Optionally, each of the plurality of test dongles further includes a first wireless transceiver and the remote controller further includes a second wireless transceiver wirelessly coupled to the first wireless transceiver to receive the analytic data.

Optionally, a transmission distance between the first wireless transceiver and the second wireless transceiver are in a range of 100 m.

Optionally, the present invention further includes a processing device. The processing device is wirelessly connected to the second wireless transceiver to receive the analytic data.

Optionally, the remote controller further includes a transmission port connected to a processing device by a transmission line, and the remote controller transmits the analytic data to the processing device via the transmission line coupling to the transmission port.

Optionally, each of the plurality of test dongles further includes a power switch configured to activate or deactivate the test dongle.

Optionally, the remote controller further includes a power switch configured to activate the remote controller to receive the analytic data from the test dongles.

Optionally, the present invention further comprising a plurality of batteries disposed in the plurality of test dongles and the remote controller.

Optionally, the batteries of the test dongles and the battery of the remote controller are disposable batteries.

Optionally, the batteries of the test dongles and the battery of the remote controller are rechargeable batteries.

Optionally, the electrochemical analysis includes a process of examining analyte, a process of executing electrochemical analysis, a process of capturing detecting signal or a process of converting detecting signal.

Optionally, the electrochemical analysis includes executing a process of electrochemical analysis, the process of electrochemical analysis is rendered based on Cyclic Voltammety (CV) method, Linear Scan Voltammety (LSV) method, Square-Wave Voltammety (SWV) method, Differential Pulse Voltammety (DPV) method, Amperometry method, Electrochemical Impedance Spectroscopy (EIS) method or Open-circuit Potential(OCP) method.

Based on the foregoing description, the multi-channel potentiostat in the present invention may be provided with advantages as follows:

1. The plurality of the test dongles may examine a number of the same or different analytes at the same time and may acquire a plurality of analysis data. The plurality of the test dongles may transmit the plurality of analysis data to the remote controller, and the remote controller can transmit the plurality of analysis data to the processing device for analysis. Hence, the plurality of analysis result may be acquired, and the examination time and the number of the examinations may be reduced. The multi-channel potentiostat may therefore elevate the convenience of use.

2. Because the size of the test dongle is small, the test dongle may be adaptable to a variety of environments and test items. For example, the test dongle may be disposed in the sewage disposal system of the chemical factory to detect the concentration of the hazardous substance, disposed in the environment with volatile toxic gas to detect the concentration of the toxic gas, or disposed in the river or pond to detect the water quality. The test dongle may also be applied for medical purposes to detect the concentration of the blood glucose of the patient, to detect the infection situation of bacteria or viruses, or to detect any physiological information of interest, thereby increasing the variety of use.

3. The test dongle, the remote controller and the processing device may communicate the analysis data with wireless communication. The examination range may be expanded and the maneuverability may be elevated.

4. Since the battery of the test dongle may utilize its USB connector to be acted as the charging connector, the USB connector of the test dongle may be inserted into the USB receiving ports (acting as the charging receiving ports) of the remote controller for power charging. The battery of the remote controller may be charged by connecting the power connector to the power outlet. The size of the test dongle and the remote controller are small and the convenience and the portability may be dramatically elevated.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a schematic diagram of the configuration of the multi-channel potentiostat of the present invention.

FIG. 2 illustrates a schematic diagram of the simulation system of the multi-channel potentiostat of the present invention.

FIG. 3 illustrates a schematic diagram of the user interface during using the processing device and showing analysis result.

FIG. 4 illustrates a flow chart of different electrochemical analysis and examination by the test dongle of the present invention.

### DETAILED DESCRIPTION OF THE PREFERRED EMBODIMENTS

For clarifying the technical feature of the embodiments of the present invention, the technical solutions in these embodiments of the present invention will be explained thoroughly and clearly. Apparently, these drawings show the embodiments of the present invention. Those skilled in the art would learn the other drawing from these drawings of the present invention without undue experiment.

Furthermore, those skilled in the art would learn the other embodiments from these embodiments of the present invention without undue experiment, and the other embodiments learned by those skilled in the art are without departing from the spirit and scope of the disclosure set forth in the claims.

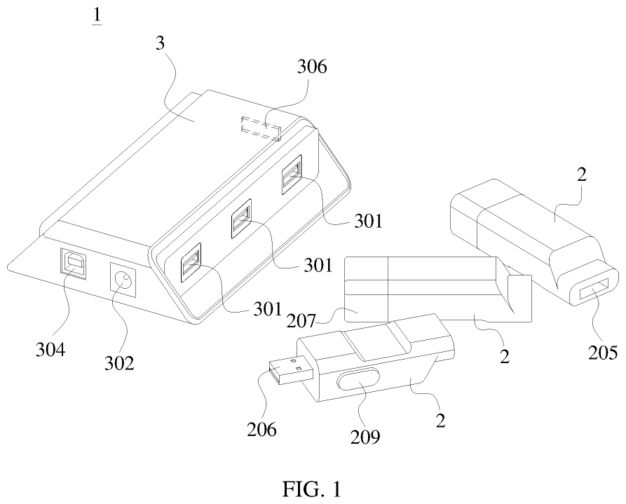

Please refer to FIG. 1, which illustrates a schematic diagram of the configuration of the multi-channel potentiostat of the present invention. The multi-channel potentiostat 1 includes one or more than one test dongles 2 and a remote controller 3. Wherein, each test dongle 2 includes a detector receiving port 205, a I/O connector 206 and a USB protective cover 207 and a power switch 209. The remote controller 3 includes a plurality of I/O receiving ports 301, a power connector 302, a transmission port 304 and a power switch 306. In one embodiment, the I/O connector 206 may be the USB connector and the I/O receiving port 301 may be the USB receiving port.

The detector receiving port 205 of the plurality of test dongles 2 may be receiving and coupled with the chemical testing piece, for example, biosensors or biochips. In one embodiment, when the analyte is liquid, the analyte may be dripped on the chemical testing piece. In another embodiment, when the analyte is gas, the chemical testing piece may be exposed to the gas. By the configuration of different chemical testing pieces, the variety of applications and the convenience of use may be elevated.

In one embodiment, the USB protective cover 207 of the plurality of test dongles 2 may be removed and the plurality of test dongles 2 may be inserted into the plurality of I/O receiving ports 301 of the remote controller 3 for transmitting the data or for charging.

In one embodiment, the number of the test dongle 2 may be one or more than one, for example, the number of the test dongles 2 may three (as illustrated in FIG. 1) or six (three on the front and three on the back), but it is not limited thereto.

When using the test dongles 2, the power switch 209 may be pressed to activate the test dongle 2 for executing electrochemical analysis. The test dongle 2 coupled with the chemical testing piece may then proceed to analysis the contents in the analyte. At the end of using the test dongle 2, the power switch 209 may be pressed to deactivate the test dongles 2.

The power line may be connected to the power connector 302 of the remote controller 3 to supply the power or for charging. In one embodiment, the transmission line may be coupled to the transmission port 304 of the remote controller 3 to connect the processing device for executing the data transmission.

When using the remote controller 3, the power switch 306 may be pressed to activate the remote controller 3 for receiving the analytic data from the coupled test dongles 2, and the remote controller 3 may in turn transmit the downloaded analytic data to the processing device for further analysis or storage. At the end of using the remote controller 3, the power switch 306 may be pressed to shut down the remote controller 3.

In one embodiment, the first wireless transceiver 208 and the battery 210 may be disposed in the test dongle 2, and the second wireless transceiver 303 and the battery 307 may be disposed in the remote controller 3. By utilizing the first wireless transceiver 208 and the second wireless transceiver 303 to facilitate wireless transmission of data, the wired connection between the test dongle 2, the remote controller 3 and the processing device 5 may be omitted. The operable range and distance of the test dongle 2, the remote controller 3 and the processing device 5 may be expanded and the maneuverability and the convenience of use may be elevated.

In one embodiment, the first and second wireless transceivers 208, 303 may be implemented with Bluetooth technology or other suitable wireless transmission technology that the transmission distance may be in the range of 100 m. Nevertheless, transmission protocol and transmission distance of the wireless transceiver may be adjusted to meet the needs of actual applications and are not limited thereto.

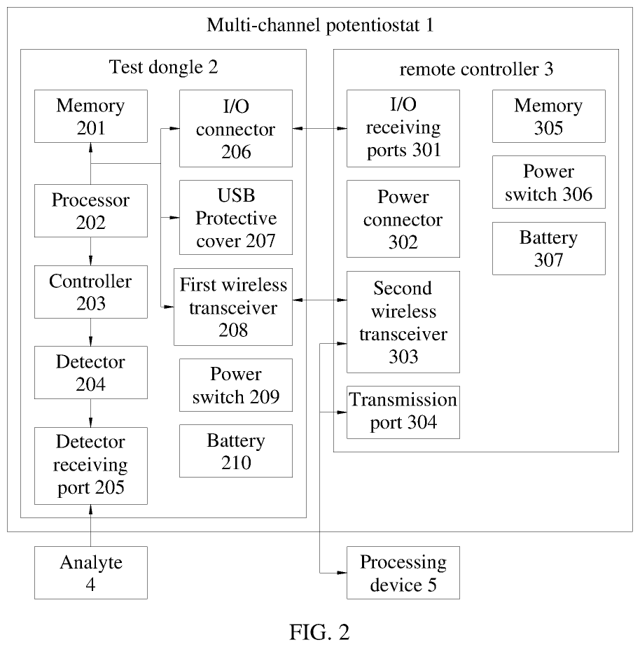

Please refer to FIG. 2, which illustrates a schematic diagram of the simulation system of the multi-channel potentiostat of the present invention. The multi-channel potentiostat 1 includes one or more than one test dongles 2 and a remote controller 3. For simplify the drawing, FIG. 2 just shows one test dongle 2 in the simulation system for describing.

The test dongle 2 includes the memory 201, the processor 202, the controller 203, the detector 204, the detector receiving port 205, the I/O connector 206, the USB protective cover 207, the first wireless transceiver 208, the power switch 209 and the battery 210. The remote controller 3 includes I/O receiving ports 301 (merely showing one USB receiving port for simplify the drawing), the power connector 302, the second wireless transceiver 303, the transmission port 304, the memory 305, the power switch 306 and the battery 307.

In one embodiment, the analyte 4 is placed on the chemical testing piece (not illustrated in the drawing) coupled to the detector receiving port 205, and the analyte 4 is delivered to the detector 204. The controller 203 then instructs the detector 204 to apply testing signal to the analyte 4 and receives the response signal from the reaction of the analyte 4. The testing signal and the response signal may be voltage signals, current signals, optical signals . . . etc, but not limited thereto. Based on the selection of the electrochemical analysis process, the voltage data and the current data are captured in the reaction time. Afterward, the processor 202 calculates the analytic data about the constitution or the concentration of the analyte and the analytic data are stored in the memory 201. And then, the I/O connector 206 may inserted into the I/O receiving port 301 of the remote controller 3 and the analytic data stored in the memory 201 may be stored in the memory 305 by the wired communication. Or the analytic data may be directly stored in the memory 305 with the wireless communication between the first wireless transceiver 208 and the second wireless transceiver 303. Finally, by inserting the transmission line into the transmission port 304 to connect to the processing device 5 via the wired transmission or by the wireless communication between the second wireless transceiver 303 and the processing device 5, the analytic data are transferred to the processing device 5 for further analysis and the analytic result may be produced.

In one embodiment, the battery 210 of the test dongle 2 and the battery 307 of the remote controller 3 are rechargeable lithium batteries. When the battery 210 of the test dongle 2 runs out of power, the I/O connector 206 may be inserted into the I/O receiving port 301 of the remote controller 3 (the I/O receiving ports 301 may act as the rechargeable receiving port), the battery 307 may provide power to the battery 210 for charging. When the battery 307 of the remote controller 3 runs out of power, the power line may be coupled to the power connector 302 to charge the battery 307 or directly provide power to the battery 307.

In another embodiment, the battery 210 of the test dongle 2 and the battery 307 of the remote controller 3 are disposable batteries. When the battery 210 and the battery 307 run out of power, the battery 210 and 307 are replaced with the new batteries.

In another embodiment, the battery 210 of the test dongle 2 is a disposable battery and the battery 307 of the remote controller 3 is a rechargeable lithium battery. When the test dongle 2 runs out of power during examination on the analyte, the battery 210 may be replaced with the new battery. The remote controller 3 may be powered by the power connector 302 coupled to the power line, and the power may be provided to the battery 307 for charging.

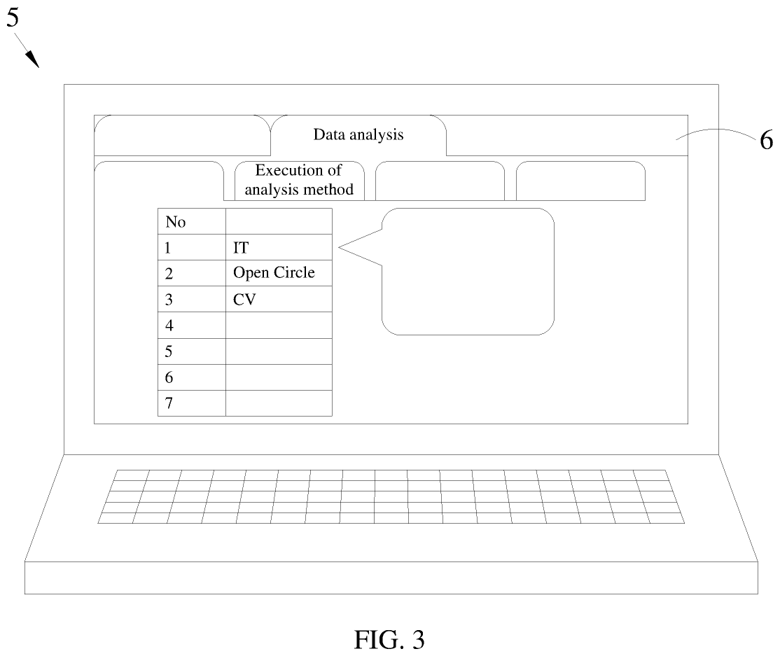

Please refer to FIG. 3, which illustrates a schematic diagram of the user interface 6 while operating the processing device 5, in which the analysis result is shown. The processing device 5 may be the processing device having the wireless communication or wired communication, such as personal computer, the laptop, the tablet or the server.

In one embodiment, the analytic result of the processing device 5 may be the result analyzed from the data which is acquired by Cyclic Voltammety(CV) method, an Amperometry method or Open-circuit Potential(OCP).

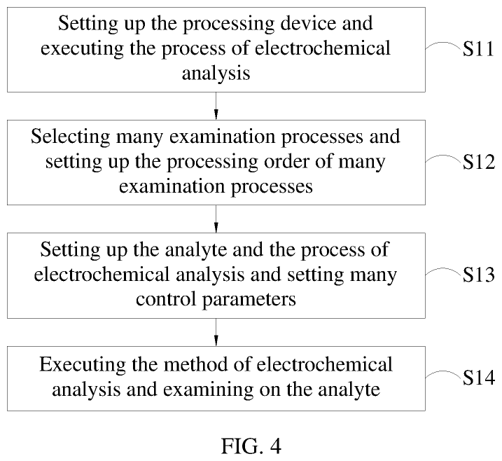

Please refer to FIG. 4, which illustrates a flow chart of different electrochemical analysis and examination by the test dongle of the present invention. The test dongle 2 sets up the different examination process of electrochemical analysis, which includes:

Step S11: Setting up the processing device and executing the process of electrochemical analysis. The processing device 5 may be the personal computer, the laptop, the tablet or the server. The memory in the processing device 5 may be the computer readable medium which stores the software process and may be a hard disk drive, a solid state drive, a flash memory or a phase-change memory. The processor of the processing device 5 may be a single-core processor, a multi-core processor or one or more processors which couples to the memory and executes the commands in the memory to perform the software process. In the process of setting up the examination process of electrochemical analysis, the setting of Step S11˜S13 may be executed in the processing device 5.

Step S12: Selecting one or more examination processes and setting up the processing order of the selected examination processes. In the process of electrochemical analysis, the selected examination processes are programmed based on the content of the analyte. The examination processes may include the process of examining analyte, the process of executing electrochemical analysis, the process of capturing detecting signal and the process of converting detecting signal. The order of the examination processes is then determined. In detail, the process of examining analyte is based on the kind of the analyte 4 and the situation of the analyte 4 during detection, in which the detector 204 of the test dongle 2 determines whether there is sufficient amount of analyte 4 for analysis, such as, by determining whether the voltage variation is above the preset value. If the detector 204 determines that the analyte 4 is sufficient, the process of electrochemical analysis may be executed. After activating the detector 204, the selected processes and order of electrochemical analysis may be applied, such as conducting one process or more processes of electrochemical analysis. During the electrochemical analysis, the response signals are acquired and the signal conversion of the response signals are undergone corresponding to the selected process and configured order of electrochemical analyses. Namely, the step by step manual operation required by the conventional process of electrochemical analysis may be replaced with the automatic batch process of electrochemical analysis provided in the present application.

Step S13: Specifying the analyte and setting up the process of electrochemical analysis and control parameters accordingly. In response to the process of electrochemical analysis selected in Step S12, the method of electrochemical analysis is further selected based on the analyte 4 and the required analysis result. The method of electrochemical analysis may be the Cyclic Voltammety (CV) method, the Linear Scan Voltammety (LSV) method, the Square-Wave Voltammety (SWV) method, a Differential Pulse Voltammety (DPV) method, an Amperometry method, Electrochemical Impedance Spectroscopy (EIS) method or Open-circuit Potential (OCP) method. According to the different method of electrochemical analysis, each of the control parameters during analyzing may be set. The control parameters may comprise the voltage, the current, the reaction time, the examination temperature, the reagent concentration or the signal capturing range.

Step S14: Executing the method of electrochemical analysis and examining on the analyte. After selecting the analyte and the method of electrochemical analysis and setting the control parameter, and the remote controller 3 is connected to the processing device 5 and the test dongle 2 is connected to the remote controller 3, the analyte 4 is then placed on the testing piece coupled to the detector receiving port 205 and the test dongle 2 conducts the examination process configured in Steps S11˜S13. Based on the different method of electrochemical analysis, the detected voltage or current may be captured. The computer is utilized to analyze the detected voltage or current and presents the analysis result to the operator.

According to the description of embodiments, the multi-channel potentiostat of the present invention has the advantages compared to the conventional potentiostat, such as examining a number of the same or different analyte at the same time, expanding the examination range and the examination sort and being portable. The multi-channel potentiostat of the present invention overcomes the shortcoming of the conventional potentiostat such as bulky in size, small examination range and the examination sort and not easy to carry.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A multi-channel potentiostat comprising
a plurality of test dongles, each configured to perform an electrochemical analysis on an analyte to produce analytic data thereof, each of the plurality of test dongles including:
a detector receiving port;
a detector coupled to the detector receiving port, the detector being configured to receive the analyte;
a controller electrically connected to the detector and instructing the detector to apply a testing signal to the analyte to obtain a response signal;
a processor electrically connected to the controller and calculating the analytic data based on the response signal; and
a first memory electrically connected to the processor to store the analytic data; and
a remote controller including a second memory, the remote controller establishing data communication with each of the plurality of test dongles to receive the analytic data stored in the first memory and store the analytic data in the second memory; and
wherein the plurality of test dongles are configured to perform the electrochemical analysis.

2. The multi-channel potentiostat according to claim 1, wherein the plurality of test dongles are detachably coupled to the remote controller.

3. The multi-channel potentiostat according to claim 2, the remote controller further including one or more I/O receiving ports and each of the plurality of test dongles further including an I/O connector, each of the I/O connector being configured to physically couple to one of the I/O receiving ports to transmit the analytic data from the plurality of test dongles to the remote controller.

4. The multi-channel potentiostat according to claim 3, wherein the remote controller provides power to the plurality of test dongles by coupling between the I/O connector and the I/O receiving ports.

5. The multi-channel potentiostat according to claim 3, each of the plurality of test dongles further including a first wireless transceiver and the remote controller further including a second wireless transceiver wirelessly coupled to the first wireless transceiver to receive the analytic data.

6. The multi-channel potentiostat according to claim 5, wherein a transmission distance between the first wireless transceiver and the second wireless transceiver are in a range of 100 m.

7. The multi-channel potentiostat according to claim 5, further comprising a processing device, the processing device wirelessly connected to the second wireless transceiver to receive the analytic data.

8. The multi-channel potentiostat according to claim 4, the remote controller further comprising:
a transmission port connected to a processing device by a transmission line, the remote controller transmitting the analytic data to the processing device via coupling the transmission line to the transmission port.

9. The multi-channel potentiostat according to claim 1, each of the plurality of test dongles further including a power switch configured to activate or deactivate the plurality of test dongle.

10. The multi-channel potentiostat according to claim 1, the remote controller further including a power switch configured to activate the remote controller to receive the analytic data from the plurality of test dongles.

11. The multi-channel potentiostat according to claim 1, further comprising a plurality of batteries disposed in the plurality of test dongles and the remote controller.

12. The multi-channel potentiostat according to claim 11, wherein the plurality of batteries of the plurality of test dongles and the battery of the remote controller are disposable batteries.

13. The multi-channel potentiostat according to claim 11, wherein the plurality of batteries of the plurality of test dongles and the battery of the remote controller are rechargeable batteries.

14. The multi-channel potentiostat according to claim 1, wherein the electrochemical analysis includes a process of examining analyte, a process of executing electrochemical analysis, a process of capturing detecting signal or a process of converting detecting signal.

15. The multi-channel potentiostat according to claim 1, wherein the electrochemical analysis includes executing a process of electrochemical analysis, the process of electrochemical analysis is rendered based on Cyclic Voltammety (CV) method, Linear Scan Voltammety (LSV) method, Square-Wave Voltammety (SWV) method, Differential Pulse Voltammety (DPV) method, Amperometry method, Electrochemical Impedance Spectroscopy (EIS) method or Open-circuit Potential(OCP) method.
